(19) United States
(12) Patent Application Publication
(10) Pub. No.: US 2015/0022626 A1
(43) Pub. Date: Jan. 22, 2015

(54) Data, Multimedia & Video Transmission Updating System

(71) Applicant: Ibrahim NAHLA, Newington, South Wales (AU)

(72) Inventor: Ibrahim Nahla, Newington (AO)

(21) Appl. No.: 14/377,713

(22) PCT Filed: Feb. 10, 2013
(86) PCT No.: PCT/AU2013/000113

§ 371 Date: Aug. 8, 2014

(30) Foreign Application Priority Data
Feb. 10, 2012 (AU) 2012900488

(51) Int. Cl. H04N 7/15; H04N 19/597; H04N 19/61

(52) U.S. Cl. CPC H04N 7/152; H04N 19/00781; H04N 19/00769
USPC 348/14.09

(57) ABSTRACT

A data processing and communications system for communications between remote stations, the apparatus comprising; a communications module; and a data processing module, a power supply including a power source for generating power and a power link to said modules; a data and power link between the communications module and the data processing module to enable communications and mutual operations therebetween. A camera and MCU for each data transmission station is provided along with a frame comparator in the MCU to select characteristic frame image changes in an image transmission and means for ascertaining characteristic data/image changes based on comparison between each of a predetermined number of per second and next camera captures.

### BACKGROUND

The present invention relates to appliances and apparatuses and more particularly relates to multi media communications systems and more particularly relates to a method of distribution of multi media in which images are distributed in real time frame by frame in a more efficient manner. More particularly the invention further relates to a method of real time frame by frame updating of media data for providing audio and/or visual communications using less data repetition. The invention further relates to a communications system which allows transmission of data and multiple use of frame by frame data to reduce the whole in part image display duplication. The present invention further relates to a system and method capable of transmitting real time quality live multimedia and Video Call, without time lagging or image. The invention further relates to a method for eliminating image freeze on a receiver monitor when high volume data is transmitted per second. The present invention further relates to a method of transmitting data in which overlapping data is a sequence of data is not transmitted to reduce the volume of data transmitted thereby increasing transmission rate of the data.

### PRIOR ART

Data communications are becoming increasingly necessary as remote communities are gradually upgraded with modern infrastructures. As remote areas infra structures improve, so too does the need and demand for modern communications improve. Electronic communications are required for a variety of purposes including medical services, including emergency response and evacuations conferencing and image transmissions. They are also required for police and law enforcement, business and entertainment services and conferencing associated therewith.

In multi media transmissions and particularly video image transmission, images are transmitted in packets of data or frame by frame. As an image changes some parts of an image in one frame are the same as corresponding parts in an adjacent frame. Transmitting a whole frame of data which has data in common with an adjacent frame is both data and time consuming. Video conferencing is playing a major role in communication, education, social activities, control and even law enforcement. Video streaming causes a massive load on networks with current streaming technologies and with increasing demand on video conferencing, multi-trillion dollars will be spent in the coming few years on networks infrastructures, governments, organizations and individuals communication budgets. Statistics show that video streaming is representing 54% of data traffic on networks and increasing by 8.5% yearly.

Systems and methods are known for transmitting real time multimedia and Video Calling data instantly using various data formats. However the known systems which employ high levels of digital data are prone to time lagging or freezing on display monitors. The unwanted freezing or lagging on receiver monitors due to large amount of data required to be transmitted per second reduces the efficiency and volume capacity of servers.

Display hardware when drawing data has a refresh rate which is the number of times in a second that a display hardware draws the data. This is distinct from the measure of frame rate in that the refresh rate includes the repeated drawing of identical frames, while frame rate measures how often a video source can feed an entire frame of new data to a display. Most movie projectors advance from one frame to the next one 24 times each second. But each frame is illuminated two or three times before the next frame is projected using a shutter in front of its lamp. As a result, the movie projector runs at 24 frames per second, but has a 48 or 72 Hz refresh rate. On CRT displays, increasing the refresh rate decreases flickering, thereby reducing eye strain. For computer programs or telemetry, the term is also applied to how frequently a datum is updated with a new external value from another source (for example; a shared public spreadsheet or hardware feed). Refresh is to upgrade and reestablish a whole or portion of a program. This could mean a programmed computer interface, an event, or a mind frame, brain or mind map. Refresh is to restore a program to a fresh platform. Refresh is also known as clearing, cleaning, and creating. In a CRT, the scan rate is controlled by a signal generated by a video controller, ordering the monitor to position the beam, ready to paint another frame. It is limited by the monitor's maximum horizontal scan rate and the resolution, since higher resolution means more scan lines. The refresh rate can be calculated from the horizontal scan rate. A monitor with a horizontal scanning frequency of 96 kHz at a resolution of 1280×1024 results in a refresh rate of 96,000/(1024×1.05)≈89 Hz (rounded down).

While flicker does not occur on LCD displays, it is still necessary to avoid modifying graphics data except during the retrace phase to prevent tearing from an image that is rendered faster than the display operates (LCDs normally always refresh at 60 frame/s). Refresh rate is the number of times per second in which the display draws the data it is being given. Since activated LCD pixels do not flash on/off between frames, LCD monitors exhibit no refresh-induced flicker, no matter how low the refresh rate. High-end LCD televisions now feature up to 600 Hz refresh rate, which requires advanced digital processing to insert additional interpolated frames between the real images to smooth the image motion. However, such high refresh rates may not be actually supported by pixel response times and the result can be visual artifacts that distort the image in unpleasant ways.

On smaller computer monitors (up to about 15″), few people notice any discomfort below 60-72 Hz. On larger CRT monitors (17″ or larger), most people experience mild discomfort unless the refresh is set to 72 Hz or higher. A rate of 100 Hz is comfortable at almost any size. However, this does not apply to LCD monitors. The closest equivalent to a refresh rate on an LCD monitor is its flame rate, which is often locked at 60 frame/s. Different operating systems set the default refresh rate differently. Microsoft Windows 95 and Windows 98 (First and Second Editions) set the refresh rate to the highest rate that they believe the display supports. Windows NT-based operating systems, such as Windows 2000, Windows XP, Windows Vista and Windows 7, set the default refresh rate to usually 60 Hz. The many variations of Linux usually set a refresh rate chosen by the user during setup of the display manager. Some full-screen applications, including some games, allow the user to reconfigure the refresh rate before entering full-screen mode, but most default to a “conservative” resolution and refresh rate. In 3D displays the effective refresh rate is halved, because each eye needs a separate picture. For this reason, it is usually recommended to use a display capable of at least 120 Hz, because divided in half this rate is again 60 Hz. Higher refresh rates result in greater image stability, for example 72 Hz non-stereo is 144 Hz stereo, and 90 Hz non-stereo is 180 Hz stereo. Most computer graphics cards and monitors cannot handle these high refresh rates, especially at higher resolutions.

A difference between 50 Hz and 60 Hz standards is the way motion pictures (film sources as opposed to video camera sources) are transferred or presented. Unlike computer monitors, and some DVDs, analog television systems use interlace, which decreases the apparent flicker by painting first the odd lines and then the even lines (these are known as fields). This doubles the refresh rate, compared to a progressive scan image at the same frame rate. As movies are usually filmed at a rate of 24 frames per second, while television sets operate at different rates, some conversion is necessary. Different techniques exist to give the viewer an optimal experience. Recent “120 Hz” LCD displays have been produced for the purpose of having smoother, more fluid motion, depending upon the source material, and any subsequent processing done to the signal.

There is a nexus between Computing Demand, Data Overload (Gridlock) and Internet Energy Use. There is increasing recognition that overloaded computer networks packed with an increasing demand for data and the increasing energy usage of the internet will impact on the speed and efficiency of future communications. Internet use and data transmission cause high energy demand and therefore higher transmission costs. These challenges are linked as to process data requires a large amount of energy. In Japan alone the Internet energy usage is set to outstrip the Japanese electrical generation capacity.

The quality of the image transmission during conferencing is important so the unwanted presence of lagging and freezing not only increase transmission time, they render the systems less reliable in that the delays caused by freezing interrupt data transmission and cause delay at the recipient end in receipt of accurate and continuous image and/or sound data. Repetition of data contributes to the phenomenon of lagging and places unwanted load on servers. In the known systems used in data transmission during video conferencing, the quality and speed of transmission are compromised as data from each frame of the video transmission even where it is partly duplicated frame by frame increases transmission time, energy consumption and in effect reduces bit rate. Typically, frame by frame transmission requires substantial duplication of data from frame to frame especially when the image does not significantly change from frame to frame.

The prior art data transmission methods can be improved by avoiding duplication/repetition of image data and provide instantaneous quality video conferencing without compromising the quality or the speed of transmission. The prior art also does not provide means to enable evaluation, updating, ranking and selection of characteristic changes between frames and data in common in sequential frames to avoid image lagging and freezing during transmission.

There is a long felt want in the field to improve the quality of transmission of image data to avoid unwanted lagging and freezing of image when the transmission has high data concentrations. There is also a need to limit the amount of transmitted data to equal only the selected frame by frame changes instead of uploading/downloading full image data for each frame, thereby increasing repetition and reducing data volume and transmission time.

There is also a long felt want to reduce the data load on transmission servers to enable transmission of less data per second but without compromise to the data quality which is transmitted and to thereby allow data to more users per second for the same server capacity by frame by frame data of changed.

### Invention

The present invention provides a system and method capable of transmitting real time quality live multimedia and Video Call, without time lagging or image freezing. The invention further provides a method for eliminating image freeze on a receiver monitor when high volume data is transmitted per second.

The invention further provides a system and associated Player, that enables a bandwidth reduction that is capable of achieving 70% to 90% reduction of data traffic for video streaming and unlimited other Media applications by eliminating repetition of data.

Furthermore, reduction of data traffic in video streaming in general and Video conference and social media in particular, will double the number of end-users for existing networks infra-structure, in meanwhile reduces the power consumption in generating network bandwidth, which means more environmental friendly and less global carbon footprint.

The multimedia and video stream frame by frame updating system (MVFU) has both features of digital video recorder and digital video server, it can work stand-alone or be used to build a powerful video surveillance network.

MVFU helps to reduce the clogged networks as well as helping to reduce the amount of power consumed by the internet.

The present invention further provides a system and method capable of transmitting real time quality live multimedia and Video Call, without time lagging or image freezing on a display monitor by allowing data which is common in each sequential frame to be retained by sequential frames thereby reducing the amount of frame by frame data repetition which is transmitted per second for each frame.

The present invention provides a method for reducing the volume of data transmission in frame by frame data transmission by eliminating data repetition in overlapping images in frame by frame media transmission, by retaining data in an image which is in common with data in a sequential images thereby reducing the volume of data transmission per second to reduce or eliminate image freeze during transmission of high volume data.

Although the present invention is particularly adaptable to video conference calling it will be appreciated that the invention can be adapted to a variety of high volume audio, audio/visual or audio data transmission applications.

In its broadest form the present invention comprises:

a system for reducing the volume of data transmission in frame by frame high volume data transmission by eliminating data repetition in overlapping images in frame by frame media transmission, the system further comprising;
a plurality of data transmission stations;
a Camera and MCU for each data transmission station;
wherein the MCU comprises frame comparator, selection means for characteristics changes based on comparison between each of 25 per second and next camera captures.

In a broad form of a method aspect the present invention comprises,

a method for reducing the volume of data transmission in frame by frame high volume data/media transmissions by eliminating data repetition in overlapping images in said frame by frame transmission, but without reducing image quality, the method comprising the steps of;
a) providing a plurality of data transmission stations;
b) providing a Camera and MCU for each data transmission station;
c) using a frame comparator in the MCU to select characteristic changes;
d) using selection means for ascertaining characteristic data/image changes based on comparison between each of 25 per second and next camera captures.

According to a preferred embodiment the method comprises the further step of: pre-processing of the image or video sequence to optimize processing in all subsequent steps.

According to a preferred embodiment a selection is based on allowing for only 200 of higher value changes every 1/25 per second video captures. It will be appreciated by persons skilled in the art that these change rates can be altered to suit particular circumstances. Preferably, the limited changes are coded, compressed and transmitted as updates to the first capture, that will be received by another MCU to be decoded, rendered and screened for the ends. Preferably the MCU comprises an intelligent program to evaluate, rank and select, compressing, transmitting, receiving and editing means.

The present invention provides a communications system and associated functions which allows transmission of data from a remote location to a control centre and which allow outputs of data using selected technologies such as but not limited to a printer.

The invention in effect integrates all the services and facilities which are normally typical of a business office to allow data processing and communications requirements to be executed in a more efficient manner than previously.

One object of the present invention is to provide a system of data transmission particularly for audio visual data transmission in which uploading/downloading of data is reduced per frame of an image. It is a further object of the invention to provide data transmission whose data volume is reduced so as to not exceed 1/20 of the value of presently required downloaded data per second. According to one embodiment the data can be transmitted at 1/200 per 10 seconds and/or for the duration of a teleconference could be dispersed to 1/1000s of a total common transmission value, which equally allows 1000s of extra users simultaneously for the same Server,

It is a further object to the invention to provide the aforesaid data transmission system and method for communications and data processing in both local and remote areas. It is a further object of the invention to provide a self contained communications and data processing system capable of use in remote and local areas and which is capable of linking to local or remote area networks.

In one broad form of an apparatus aspect, the present invention comprises:

a data processing and communications system for communications between remote stations
the apparatus comprising;
a communications module; and
a data processing module,
a power supply including a power source for generating power and a power link to said modules;
a data and power link between the communications module and the data processing module to enable communications and mutual operations therebetween;
a Camera and MCU for each data transmission station;
a frame comparator in the MCU to select characteristic frame image changes; means for ascertaining characteristic data/Image changes based on comparison between each of 25 per second and next camera captures.

In another broad form the present invention comprises:

a method of data processing and communications between remote stations using an apparatus comprising;
providing a communications module; and
a data processing module,
a power supply including a power source for generating power and a power link to said modules;
a data and power link between the communications module and the data processing module to enable communications and mutual operations therebetween;
a Camera and MCU for each data transmission station;
a frame comparator in the MCU to select characteristic frame image changes; means for ascertaining characteristic data/image changes based on comparison between each of 25 per second and next camera captures; the method comprising;
a) transmitting video data for a predetermined period of time at a predetermined rate of download;
b) using a module to ascertain image changes frame by frame;
c) identifying a base frame received by a receiver and using that frame to update at approximately 25 times per second;
d) evaluating changes by comparing data from a first frame with data on at least one sequential frame;
e) creating vectors of changes in one frame compared to the at least one sequential frame;
f) decoding the vectors and updating the first frame with identified changes;
g) repeating the above steps during transmission of a video image for a potentially unlimited number of frames.

According to one embodiment the changes are captured and identified by using codes, coded vectors or frame mapping saved on a base frame. According to one embodiment, a captured frame is sent every 3-4 seconds to the receiver end as a test frame for correction, calibration or adjustments to determine if a new base frame is required. It will be appreciated that this time span is non limiting and can be increased or reduced from a preferred time frame. Updating time can also be varied above or below 25 times per second.

The system of the present invention includes proprietary or purpose written software which enables the aforesaid transmission method. According to one embodiment, software can adapt to transmission times and identify images and determine suitable transmission values in each circumstance. The software is intelligent and capable of “learning” what transmission rates should apply in each case. The software recognizes data/image changes required and can adapts by creating according to one embodiment, neural networks.

In another broad form the present invention comprises:

a self contained communications system including a data processing and communications module for communications, the system comprising;
a communications and data processing module,
a power supply including a power source for generating power and a power link to said modules;
means enabling the office to link to remote external communications infrastructure;
means for ascertaining characteristic data/image changes based on comparison between each of 25 per second and next camera captures.

According to one embodiment the communications system employs wireless connections.

The system preferably incorporates existing off the shelf components to house and power a data processing module and communications module. The system provides a communications facility which is capable of inclusion in a network of existing infrastructure facilities or a network of like fixed or mobile office systems.

Preferably, communications to and from a communications apparatus is provided by the most optimal link available in the locality in which the system is used. Typically the communications module can link to a LAN, a 3G or a satellite link. According to one embodiment the system allows an option of working offline and or caching data on a local server.

The present invention provides an alternative to the known prior art and the shortcomings identified. The foregoing and other objects and advantages will appear from the description to follow. In the description reference is made to the accompanying representations, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts throughout the several views. The following detailed description is, therefore, not to be taken in a limiting sense, and the scope of the present invention is best defined by the appended claims.

### BRIEF DESCRIPTION OF ILLUSTRATIONS

The present invention will now be described in more details according to a preferred embodiment and with reference to the accompanying illustrations, wherein;

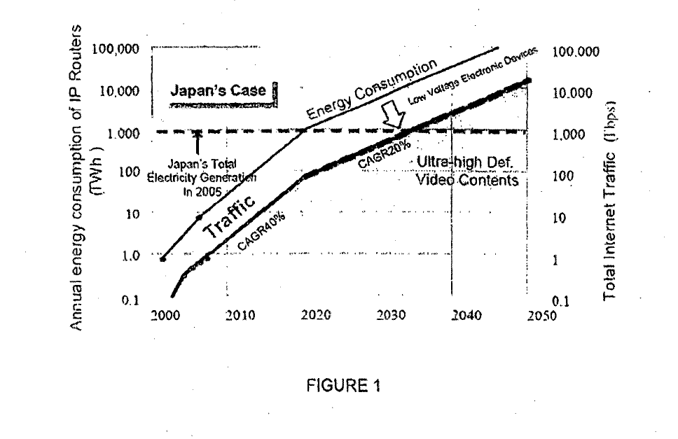

FIG. 1 shows a graph of projected energy consumption versus time based on projected increase in internet traffic.

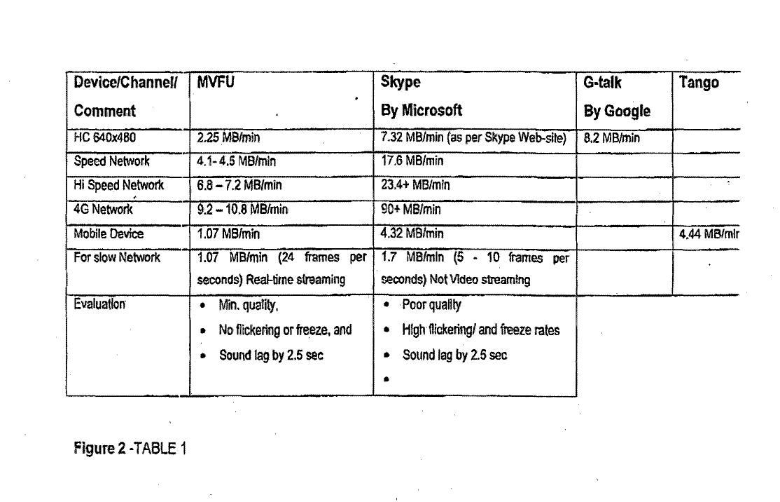

FIG. 2 shows in a comparative Table 1 that the MVFU to achieve considerable savings when compared to leading brand videoconferencing systems on real-time measured rates of data transferred.

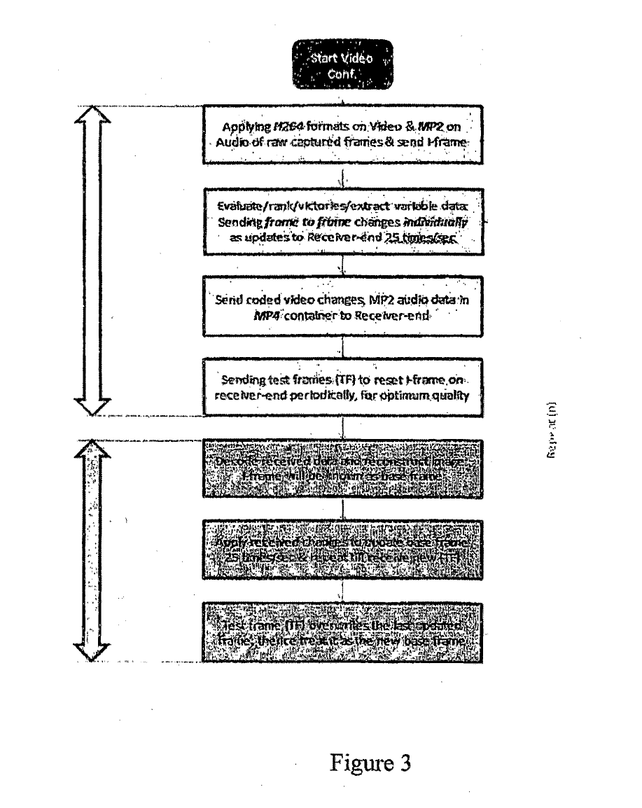

FIG. 3 shows a schematic layout of a system for frame by frame change according to a preferred embodiment;

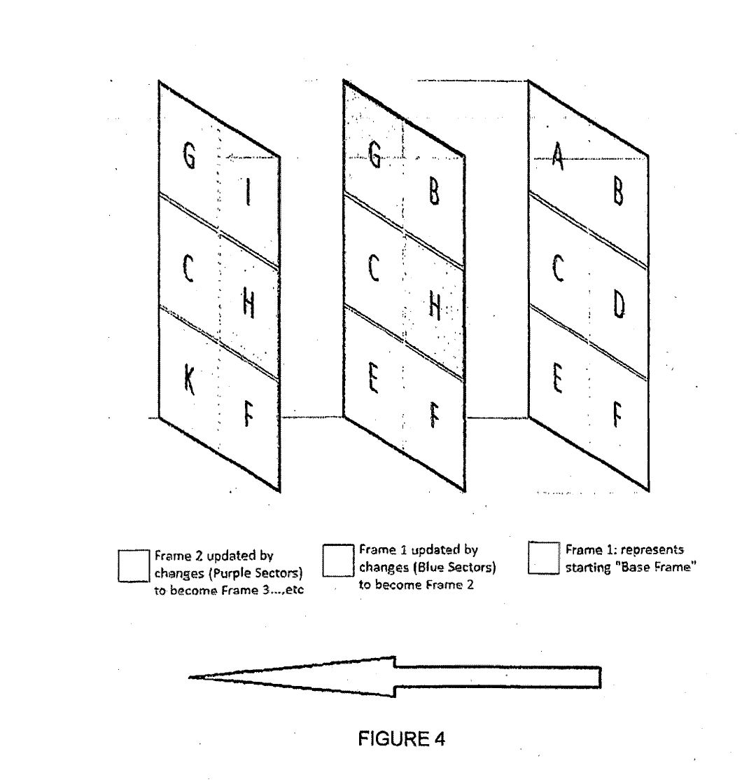

FIG. 4 shows a simple example of the methodology of the MVFU to extract and transmit changes to update the main frame.

### DETAILED DESCRIPTION

The examples referred to herein are illustrative and are not to be regarded as limiting the scope of the invention. While various embodiments of the invention have been described herein, it will be appreciated that these are capable of modification, and therefore the disclosures herein are not to be construed as limiting of the precise details set forth, but to avail such changes and alterations as fall within the purview of the description. The communications system to be described in more detail below is proposed for use in a variety of applications but is particularly suited to video conferencing.

The present invention provides a data transmission system and method capable of transmitting real time multimedia and Video Calling data instantly, without time lagging or a freezing appearance on a receiver's monitor due to large amount of data required to be transmitted per second and improving the image quality while decreasing data transmission rate. The invention provides intelligent techniques to generate instantaneously quality Video conferences without compromising the quality nor the speed of transmission, including the preprocessing of the image or video sequence to optimize processing in all subsequent steps. In particular, the invention relates to the use of updating quality captures for both the character/s and background 25 times per second. The invention further comprises a comparator that uses intelligent self-training program to evaluate, rank and select characteristics changes between each captured frame and the next captured frame. Characteristics which may change include such aspects as facial and body expressions/movements.

FIG. 1 shows a graph of projected energy consumption versus time based on projected increase in internet traffic.

FIG. 2 shows in Table 1 that the MVFU to achieve considerable savings when compared to leading brand videoconferencing systems on real-time measured rates of data transferred.

Preferably, the selections of changed characteristics are limited to the highest 200 changes (the most effective changes), in value. Then these changes are transferred to a first or original frame (that been previously captured and transmitted to the other end MCU), as updates for the first frame to be edited by the receiving end MCU, particularly to limit the amount of transmitted data to equal only the selected changes instead of uploading/downloading captures of full data.

Preferably the updates will be generated 25 times per second in order to continuously change the receiver monitor to the sender movements and expressions. The MCU comprises a further training logic program for promptness achieving the said actions several times per second; where the target is to repeat the tasks every 4 milliseconds.

An ideal speed can be created for best quality capture updates in a given transmission. In a case when the changes exceed a predetermined value (before the selection process), to significantly close or equal in value to a new captured frame, the MCU will allow for a new capture to be transmitted as to the receiving end MCU and start to work on it as the new first capture. This may need 25 updates per second.

The apparatus used for the method aspect of the invention, in the case of video conferencing, preferably includes;

### a Camera;

an MCU for each video call/conference end;
where the MCU comprises a frame comparator, selection means for characteristic changes based on a comparison between each of the 25 per second and next camera captures.

The limited changes are then coded, compressed and transmitted as updates to the previous capture, that will be received by the other end MCU to be decoded, rendered and screened. As a result: uploading/downloading amount of data will be in minimum value; ideally not exceeding 1/20 value of present required downloaded data per second, 1/200 per 10 seconds and/or for the duration of the conference could be dispersed to 1/1000s of a total common transmission value, which may equally allow 1000s of extra users for the same Server, simultaneously.

According to one application of the system, when the system is in wireless operation, it will look for the best link to the internet it can find, first looking for a LAN connection, then for a 3G connection, then if none of these are available it prompts for the satellite link to be set up. A router can obtain an IP address from a network to which it has connected. The router can then connect to the internet. If the LAN is not available, the systems checks for a 3G connection. If it is available it will connect automatically. If it is not available a test is run for a satellite connection.

According to a preferred embodiment the multimedia and video stream frame by frame updating system has a variety of applications in the context of data streaming.

### Example 1

Video conference in Organisational network features: Bi-directional video/audio conference with caching, storing, retrieval and playback capabilities.

### Example 2

Video conference on-line network features: Bi-directional video/audio conference with caching, storing, retrieval and playback through cloud capabilities.

Applications other than Webcams: a Multimedia streaming file (a library file) is created to store downloads of other Media sources to apply MVFU methodology and technique.

According to a method aspect in the Multimedia & VIDEO Stream Frame By Frame Update [MVFU] H264 is applied on a Media source such as a Webcam to allow changes between frames extractions, compressing and encoding. The player used in accordance with the present invention is windows based, but other applications (versions) for Mac, and Linux can be based on the same MVFU methodology and architecture. The MVFU methodology includes the following features:
a Test frame every 1, 2 or 4 Sec/25, 50 OR 100 frames respectively can be generated (if needed) for more Quality: for smooth playback with minimum flickering;
Generated files sizes are only 20% of the full size Video Stream files and replace original files for less storage and more convenient PC usages and Data exchange over the Net.
Real-time tests and comparisons with different players in bandwidth reductions are conducted.
Back up line application with capabilities for retrievals Caching for cloud application
Development of own player for optimal result
The player developments features:
   It is capable of Adopting MVFU methodology and techniques
   Smart formula for Auto-scalability according to Bandwidth strength
   Manual selection to allow users to control Data usage (i.e. can scale down resolution and resize viewer window (for example: low data=lower resolution=smaller viewer)
   Video playback enhancements software and viewer filtering.

According to a preferred embodiment there is provided a player in the form of software which can be uploaded by a user for integration with existing hardware such as a mac or Microsoft computer. The player is optimised for compressing file data and increasing data transmission particularly via the internet. The invention is described with reference to a typical video conferencing which involves high data transmissions. H264 format is applied on video data and MP2 is applied on audio of raw captured frames is employed. H264 is a standard for video compression, and is currently one of the most commonly used formats for the recording, compression, and distribution of high definition video.

H.264 is the best known as being one of the standards for Blu-ray Discs. Currently, all Blu-ray Disc players must be able to decode H.264. It is also widely used by streaming internet sources, such as videos from Vimeo, YouTube, the iTunes Store, web software such as the Adobe Flash Player and Microsoft Silverlight

The intent of the H1264/AVC project was to create a standard capable of providing good video quality at substantially lower bit rates than previous standards (i.e., half or less the bit rate of MPEG-2, H.263, or MPEG-4 Part 2), without increasing the complexity of design so much that it would be impractical or excessively expensive to implement. The standard has been applied to a wide variety of applications on a wide variety of networks and systems, including low and high bit rates, low and high resolution video, DVD storage, multimedia telephony systems. The H.264 standard decodes at least one, but not necessarily all profiles. The decoder specification describes which profiles can be decoded. In the first project to extend the original standard, the JVT then developed what was called the Fidelity Range Extensions (FRExt). These extensions enabled higher quality video coding by supporting increased sample bit depth precision and higher-resolution color.

Added to the standard was Multiview Video Coding (MVC) which enables the construction of bitstreams that represent more than one view of a video scene. An important example of this functionality is stereoscopic 3D video coding. An objective was to double the coding efficiency (which means halving the bit rate necessary for a given level of fidelity) in comparison to any other existing video coding standards for a broad variety of applications. The H.264 video format has a very broad application range that covers all forms of digital compressed video from low bit-rate Internet streaming applications to HDTV broadcast and Digital Cinema applications with nearly lossless coding. With the use of H.264, bit rate savings of 50% or more are possible. H.264 has given the same Digital Satellite TV quality as current MPEG-2 with less than half the bitrate, with current MPEG-2 implementations working at around 3.5 Mbit/s and H.264 at only 1.5 Mbit/s.

Both the Blu-ray Disc format and the now-discontinued HD DVD format include the H.264/AVC High Profile as one of 3 mandatory video compression formats. Various recording formats are known such as high-definition AVCHD that uses H.264 (conforming to H.264 while adding additional application-specific features and constraints). Other formats include AVC-intra which is an intra frame-only compression format. XAVC can support 4K resolution (4096×2160 and 3840×2160) at up to 60 frames per second (fps).

Features of H.264 has been improved to include a number of new features that allow it to compress video much more effectively than older standards and to provide more flexibility for application to a wide variety of network environments. This is in contrast to prior standards, where the limit was typically one; or, in the case of conventional B-frames, two. This particular feature usually allows modest improvements in bit rate and quality in most scenes. But in certain types of scenes, such as those with repetitive motion or back-and-forth scene cuts or uncovered background areas, it allows a significant reduction in bit rate while maintaining clarity. Weighted prediction, allowing an encoder to specify the use of a scaling and offset when performing motion compensation, and providing a significant benefit in performance in special cases-such as fade-to-black, fade-in, and cross-fade transitions. This includes implicit weighted prediction for B-frames. The supported luma prediction block sizes include 16×16, 16×8, 8×16, 8×8, 8×4, 4×8, and 4×4, many of which can be used together in a single macroblock. The ability to use any macroblock type in B-frames including 1-macroblocks, resulting in much more efficient encoding when using B-frame

FIG. 3 shows a schematic layout of a system for frame by frame change according to a preferred embodiment. Mathematical data streaming need less than 20% of the normal video streaming. Therefore, the approximate reduction of the video streaming using MVFU compared with other existing techniques can be calculated as follows: Approximate theoretical scalable math: No of frames per second=25Math data size compared to video frame=10% Total number of test frames per second=1Size of data on the remaining 24 frames=24×10%=2.4. Total size required by MVFU/second of video streaming=1+2.4=3.4. Saving from conventional video streaming=25−3.4=21.6/25=86.4%. Sending a test frame every 2 sec will save=50−5.9=44.1/50=88.2% . . . etc

FIG. 4 shows a simple example of the methodology of the MVFU to extract and transmit changes to update the main frame. FIG. 4 shows a series of frames—Frame 1, Frame 2 and Frame 3. Frame 1 on the right hand side represents the start or base frame. Frame 1 is divided into frame segments A, B, C, D, E, F. In Frame 2 segments A and D are updated with changed data identified by segments G and H (blue segments). In Frame 3 segments G and H are retained from frame 2 and segments C and F are retained from frame 1. 3 In frame 3 segments B and E from frame 1 and 2 are updated shown by segments I and K (purple segments).

Extract changes between frames 1 & 2 in Sender's unit comparator. Transmit changes only to Receiver end as a frame layer. Update Frame 1 in Receiver's unit with changes layer to generate Frame 2. Sound transmitted separately to Receiver unit to Sync with Video frames in streaming

The system according to the present invention applies H264 on Webcam Media source to allow changes between frames extractions, compressing and encoding. The new application is window based, allowing other applications (versions) for Mac, and Linux can be based on MVFU same methodology and architecture.

To get near equal results H264 format was applied on Webcam raw captures (video input) and MP2 on audio input from native or network, capturing images up to 25 frames per second from USB camera or other, H264 video encoder and MP2 or MP3 audio encoder, high quality video and audio effect with a few bandwidth. Record file format may be AVI or MPEG and so on, it can be played with Windows Media Player or Real Player. It can use manual record, scheduled record, or motion record, snapshot a JPEG image from you see, detailed log file and help files. This software has both features of digital video recorder and digital video server; it can work stand-alone or be used to build a powerful surveillance network.

The MVFU system, shares compression results of different video formats. H.264, or MPEG-4 (MP4) format, gives best compression by transmitting only changes between frames, and not the whole frame. A captured sequential frame often has a combination of variable data from frame to sequential frame and identical data from frame to sequential frame. An initial-frame is captured and H264 and MP2 formats are applied on raw captured frames. An initial frame is sent to the player. An evaluation takes place and the variable data is extracted. Frame to frame changes are sent as updates to a receiver end 25 times per second. Coded video changes MP2 audio data in MP4 container to the receiver. Test frames are sent to reset the initial base frame at the receiver end periodically to optimise quality. Received data is decoded and an image reconstructed. Received changes are applied to update the base from 25 times per second and this is repeated until receipt of a new test frame. The test frame overwrites the last updated frame which is then treated as the new base frame.

The system according to the present invention employs frame by frame comparison, and transmits changes only to the network. This is done using the earlier described H264 format. Since H264 is raw video only format, it cannot send audio. To incorporate audio, the system employs mp2 format, also transmitted in real time. According to one embodiment frames are sent (I-frame) every 02 seconds. This duration can be configured for lower consumption of bandwidth. Live transmission cannot be done by composing a file and then transmitting as compressed format. Each frame is individually to the other end (buffering is required but minimised for real time video transfer).

An important feature of the present invention is that it has the capacity in the (image) player software to update changes only in a sequence of frame by frame image and sound data transmissions. The updating is based on compressing files allowing a screen density reduction. Various frame by frame update relates are contemplated—for example 2.5 frames per second. Time is reduced by replacing screen frames. H264 extracts data from a previous frame and sends only changes for each frame individually every 4 milliseconds starting with a reference i-frame.

The main objective is to avoid lagging and freezing to provide a smooth image in real time. H264 need buffering and delivering which can contribute to lagging. H264 processes 10 frames then sends those frames. The system of the present invention sends only the frame by frame changes which saves up to 80% of bandwidth usage. This improves transmission rates. Lagging can be up to 2 seconds due to buffering which is a function of the speed of download of data in conventional transmissions. In motion transmission the system only sends the frame changes as the sequential frame has the material in common. The player can allow the user to manage from by frame updating quality required of which the network will allow in each case. Reducing resolution can reduce data required but the quality can be determined by the user. The present invention introduces a new solution for bandwidth reduction by more than 50% for video streaming with unlimited other Media applications. Furthermore, reduction of data traffic in video streaming in general and Video conference and social media in particular, will double the number of end-users for existing networks infra-structure, reduces the power consumption in generating network bandwidth, which means more environmental friendly and less global carbon footprint.

The MVFU Player is a network player which works in different modules, and with different applications. Accordingly the player is capable of the following:

reading audio/video from mic/webcam and encoding, transmitting over a network;
extracting video only from streamed video over a network, reconstructing and displaying;
extracting audio only from the streamed audio over network, and playing.

The above features are integrated in into a single application, which is the MVFU Player. The MVFU uses are series of internal algorithms adapted to enable the above operations.

An advantage of the present invention is that only 2.5% of network is consumed thereby saving 80% bandwidth consumption, as compared to the known formats such as MPG and MJPEG counterparts, which consume up to 12.5% of the network. A further advantage is the elimination of lagging in playback, improved resolution of images. In a case where the system is used for such activities as skype video communications a data usage indicating icon is displayed on the screen to show data transmission rate which can be compared to a conventional skype communication without the player according to the invention. The player software which can be downloaded by the user can be tailored for the particular user so that the user can manipulate/adjust the transmission rates and image quality which is related to data usage rate by adjusting frame rate. Users are able to add auto & manual scale down selection mode features to Players. The software is adaptable to other applications (versions) for Mac, and Linux can be based on MVFU same methodology and architecture

It will be recognised by persons skilled in the art that numerous variations and modifications may be made to the invention broadly described herein without departing from the overall spirit and scope of the invention.

1. A system for reducing the volume of data transmission in sequential data transmission by eliminating from said data transmissions, transmission of identical data occurring in sequential packages of data so that only data which is not overlapping with a preceding data set is transmitted, thereby reducing the volume of data transmission per second to reduce or eliminate freeze during transmission of high volume data.

2. A system according to claim 1 wherein the data packages include sound data.

3. A system according to claim 2 wherein the data packages include frame by frame images.

4. A system according to claim 3 wherein the data packages include frame by frame images and sound data.

5. A system according to claim 4 wherein sequential data packages include overlapping data; wherein the data which overlaps during data transmission is retained to avoid repetition of data by retaining data in a data package which is in common with data in a sequential data package.

6. A system according to claim 5 wherein eliminating repetition of data in a data package eliminates transmission freeze when buffering is slower than data transmission.

7. A system according to claim 6 wherein the transmission freeze is image freeze on a receiver monitor when high volume data is transmitted per second.

8. A system for reducing the volume of data transmission in frame by frame high volume data transmission by eliminating data repetition in overlapping images in frame by frame media transmission, the system further comprising;
a plurality of data transmission stations;
a Camera and MCU for each data transmission station;
wherein the MCU comprises frame comparator, selection means for characteristics changes based on comparison between each of 25 per second and next camera captures.

9. A data processing and communications system for communications between remote stations
the apparatus comprising;
a communications module; and
a data processing module,
a power supply including a power source for generating power and a power link to said modules;
a data and power link between the communications module and the data processing module to enable communications and mutual operations therebetween;
a Camera and MCU for each data transmission station;
a frame comparator in the MCU to select characteristic frame image changes;
means for ascertaining characteristic data/image changes based on comparison between each of 25 per second and next camera captures.

10. A method for reducing the volume of data transmission in frame by frame high volume data/media transmissions by eliminating data repetition in overlapping images in said frame by frame transmission, but without reducing-image quality, the method comprising the steps of;
a) providing a plurality of data transmission stations;
b) providing a Camera and MCU for each data transmission station;
c) using a frame comparator in the MCU to select characteristic changes;
d) using selection means for ascertaining characteristic data/image changes based on comparison between each of 25 per second and next camera captures.

11. A method according to claim 10 comprising the further step of: pre-processing of the image or video sequence to optimize processing in all subsequent steps.

12. A method according to claim 11 comprising the further step of providing an MCU which comprises an intelligent program to evaluate, rank and select, compress, transmit, receive and edit data;

13. A method according to claim 12 comprising the further step of allowing the selecting means to provide changes that are coded, compressed and transmitted as updates to a first capture, that will be received by another MCU to be decoded, rendered and screened for the ends.

14. A method according to claim 13 wherein a change rate selection is based on allowing for only 200 of higher value changes every 1/25 per second video captures.

15. A method of data processing and communications between remote stations
using an apparatus comprising;
providing a communications module; and
a data processing module,
a power supply including a power source for generating power and a power link to said modules;
a data and power link between the communications module and the data processing module to enable communications and mutual operations therebetween;
a Camera and MCU for each data transmission station;
a frame comparator in the MCU to select characteristic frame image changes;
means for ascertaining characteristic data/image changes based on comparison between each of 25 per second and next camera captures;
the method comprising;
a) transmitting video data for a predetermined period of time at a predetermined rate of download;
b) using a nodule to ascertain image changes frame by frame;
c) identifying a base frame received by a receiver and using that frame to update at approximately 25 times per second;
d) evaluating changes by comparing data from a first frame with data on at least one sequential frame;
e) creating vectors of changes in one frame compared to the at least one sequential frame;
f) decoding the vectors and updating the first frame with identified changes;
g) repeating the above steps during transmission of a video image for a potentially unlimited number of frames.

16. A method according to claim 15 wherein the data comprises audio visual frame by frame data.

17. A method according to claim 16 wherein data overlapping in adjacent frames is retained to avoid repetition of data.

18. A method according to claim 17 wherein transmitted data is reduced per frame of an image.

19. A method according to claim 18 wherein the means for reducing repetition of data in data transmission is integrated into a control centre which controls transmission of data between transmission and receiving devices.

20. A method according to claim 19 wherein the data is transmitted at 1/200 per 10 seconds and/or for the duration of a transmission sequence.

21. A method according to claim 20 wherein data is image an audio data transmitted in a teleconference.

22. A method according to claim 21 wherein data is dispersed to 1/1000s of a total common transmission value, thereby allowing a potentially unlimited number of users to simultaneously receiving data from the same Server,

23. A method according to claim 22 wherein the data transmission is local.

24. A method according to claim 23 wherein the data transmission is between remote stations.

25. A method according to claim 24 wherein said data is transmitted in real time.

26. A method according to claim 25 wherein said data is live multimedia and Video Call. Data.

27. A method according to claim 26 wherein data is transmitted without time lagging or image freezing by avoiding repetition of data.
